(19) United States
(12) Patent Application Publication
(10) Pub. No.: US 2018/0210295 A1
(43) Pub. Date: Jul. 26, 2018

(54) ARRAY SUBSTRATE, COLOR FILM SUBSTRATE AND LIQUID CRYSTAL PANEL

(71) Applicant: Shenzhen China Star Optoelectronics Technology Co., Ltd., Shenzhen, Guangdong (CN)

(72) Inventor: Yanjun SONG, Shenzhen, Guangdong (CN)

(73) Assignee: Shenzhen China Star Optoelectronics Technology Co., Ltd., Shenzhen, Guangdong (CN)

(21) Appl. No.: 15/502,576

(22) PCT Filed: Jan. 17, 2017
(86) PCT No.: PCT/CN2017/071328

§ 371 Date: Feb. 8, 2017

(30) Foreign Application Priority Data
Dec. 22, 2016 (CN) 201611200394.0

(51) Int. Cl. G02F 1/1343; G02F 1/1368; G02F 1/1337; G02F 1/1333; G02F 1/1335; G02F 1/1339

(52) U.S. Cl. CPC G02F 1/134363; G02F 1/1368; G02F 1/1337; G02F 1/133345; G02F 1/133514; G02F 2001/133742; G02F 1/133788; G02F 1/13394; G02F 2201/123; G02F 2201/121; G02F 1/133512

(57) ABSTRACT

The present disclosure discloses an array substrate for a liquid crystal panel, which includes: a substrate, a plurality of thin film transistors; a flat layer; a plurality of first common electrodes and a plurality of pixel electrodes, the first common electrode and the pixel electrode being electrically insulated from each other; and a first alignment film layer arranged on the first common electrode and the pixel electrode, and the first alignment film layer is an alignment film layer capable of realizing vertical photo alignment. The present disclosure further discloses a color film substrate, a liquid crystal panel and a liquid crystal display. The present disclosure combines the characteristics of the VA display mode and the IPS display mode so that the liquid crystal panel has a high contrast ratio and a high transmittance, and also has characteristics of fast response and wide viewing angle.

### FIELD OF THE DISCLOSURE

The present disclosure relates to a liquid crystal display technology field, and more particularly to an array substrate, a color film substrate and a liquid crystal panel.

### BACKGROUND OF THE DISCLOSURE

With the optical and semiconductor technology evolution, but also led to the vigorous development of the flat panel displays, in many flat panel displays, the liquid crystal display (LCD) has been used in all aspects of production and life because of its high space efficiency, low power consumption, no radiation and low electromagnetic interference.

The liquid crystal display generally includes a liquid crystal panel and a backlight module arranged relatively in which the backlight module is required to provide uniform light to the liquid crystal panel so that the liquid crystal panel displays the image because the liquid crystal panel cannot emit light. Common LCD panel display modes include TN (twisted nematic) mode, VA (vertical alignment) mode, IPS (in-plane switching) mode, and so on.

Wherein the VA display mode refers to a display mode in which the liquid crystal molecules are vertically aligned with the substrate. The VA display mode LCD panel with high contrast, high transmittance screen display, but the viewing angle is poor. The IPS display mode refers to the display mode in which the liquid crystal molecules are arranged horizontally. IPS display mode LCD panel has fast response and wide viewing angle characteristics.

### SUMMARY OF THE DISCLOSURE

An object of the present disclosure is to provide an array substrate, a color film substrate, a liquid crystal panel and a liquid crystal display in combination with the VA display mode and the IPS display mode.

According to an aspect of the present disclosure, there is provided an array substrate for a liquid crystal panel including a substrate, a plurality of thin film transistors arrayed on the substrate; a flat layer arranged on the substrate and covering the plurality of thin film transistors; a plurality of first common electrodes and a plurality of pixel electrodes, the first common electrode and the pixel electrode being alternately arranged on the flat layer, the first common electrode and the pixel electrode being electrically insulated from each other; and a first alignment film layer arranged on the first common electrode and the pixel electrode, and the first alignment film layer is an alignment film layer capable of realizing vertical photo alignment.

Wherein, the array substrate further includes: a plurality of insulators each disposed between its corresponding pixel electrode and the flat layer, each first common electrode is located between its corresponding two adjacent insulators.

Wherein, the insulator and/or the first common electrode and/or the pixel electrode are in a stripe shape.

Wherein, the thin film transistor includes: a gate electrode arranged on the substrate, a gate insulating layer arranged on the gate electrode, an active layer arranged on the gate insulating layer and a source electrode and a drain electrode arranged on the active layer; wherein a pixel electrode arranged on each thin film transistor penetrates its corresponding insulator and the flat layer to contact the drain electrode.

According to another aspect of the present disclosure, there is also provided a color film substrate for a liquid crystal panel, including: a substrate; a black matrix arranged on the substrate and limiting a plurality of pixel areas; a plurality of colored light blocking blocks arranged on the substrate, each colored light blocking block being located in its corresponding pixel area; a insulating layer arranged on the black matrix and the plurality of colored light blocking blocks; a second common electrode arranged on the insulating layer; and a second alignment film layer arranged on the second common electrode, and the second alignment film layer is an alignment film layer capable of realizing a vertical photo alignment.

Wherein, the colored light blocking block is a red light blocking block or a green light blocking block or a blue light blocking block, and the plurality of colored light blocking blocks include a red light blocking block, a green light blocking block and a blue light blocking block.

According to the other aspect of the present disclosure, there is provided a liquid crystal panel including: the array substrate; the color film substrate, wherein the color film substrate is arranged in a pair with the array substrate; and a liquid crystal layer arranged between the array substrate and the color film substrate.

Wherein, the liquid crystal molecules in the liquid crystal layer are aligned in the following manner: the first alignment film layer and the second alignment film layer are respectively subjected to UV exposure using ultraviolet light having a wavelength of 200 nm to 500 nm, and the liquid crystal molecules are caused to form a pre-deflection at a predetermined angle.

Wherein, the pre-deflection direction of the liquid crystal molecules near the first alignment film layer of the liquid crystal layer antiparallel to the pre-deflection direction of the liquid crystal molecules near the second alignment film layer of the liquid crystal layer.

Wherein, the liquid crystal panel further includes: a spacer arranged between the color film substrate and the array substrate, and the spacers are used for maintaining a pitch between the color film substrate and the array substrate.

Advantageous effects of the present disclosure: the present disclosure combines the characteristics of the VA display mode and the IPS display mode so that the liquid crystal panel has a high contrast ratio and a high transmittance, and also has characteristics of fast response and wide viewing angle.

### BRIEF DESCRIPTION OF THE DRAWINGS

The above and other aspects, features and advantages of the embodiments of the present disclosure will become more apparent from the following description taken in conjunction with the accompanying drawings in which:

FIG. 1 is a schematic structural view of the liquid crystal panel of the embodiment of the present disclosure;

FIG. 2 is a schematic structural view of the liquid crystal display of the embodiment of the present disclosure.

### DETAILED DESCRIPTION OF PREFERRED EMBODIMENTS

Hereinafter, embodiments of the present disclosure will be described in detail with reference to the accompanying drawings. However, in many different forms and embodiments of the present disclosure, and the disclosure should not be construed as limited to the specific embodiments set forth herein. Rather, these embodiments are provided to explain the principles of the disclosure and its practical application so that others skilled in the art to understand the disclosure for various embodiments and various modifications suited to the particular intended application.

In the drawings, the device for clarity, exaggerated thickness of layers and regions. The same reference numerals in the drawings refer to like elements throughout.

It will also be understood that when an element is referred to as being placed “above” or “on” another element, it may be disposed directly on the other element, or intervening elements may also be present.

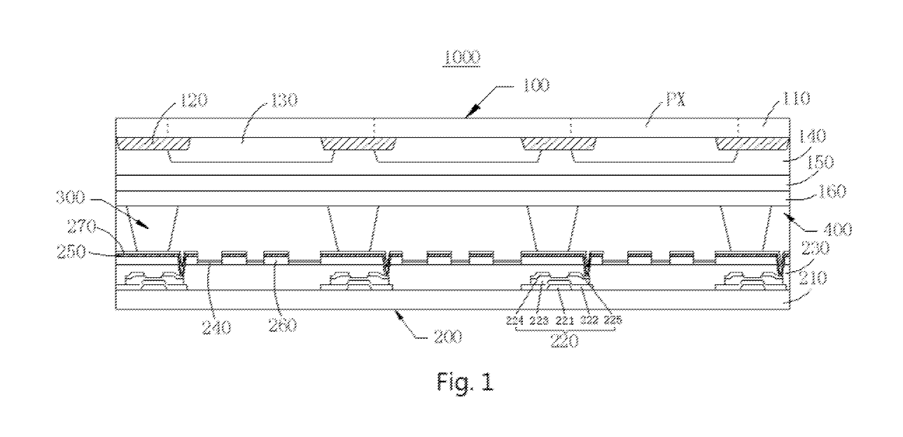

FIG. 1 is a schematic structural view of the liquid crystal panel of the embodiment of the present disclosure;

Refer to FIG. 1, the liquid crystal panel 1000 according to the present disclosure includes: a color film substrate (or CF substrate) 100, an array substrate 200, a spacer 300 and a liquid crystal layer 400.

The color film substrate 100 is arranged in a pair with the array substrate 200. The liquid crystal layer 400 is arranged between the color film substrate 100 and the array substrate 200, the liquid crystal layer 400 includes a plurality of positive type liquid crystal molecules.

As an embodiment of the present disclosure, the spacer 300 are arranged between the color film substrate 100 and the array substrate 200 so as to maintain a distance between the color film substrate 100 and the array substrate 200.

The color film substrate 100 includes: a first substrate 110, a black matrix 120, a plurality of colored light blocking blocks 130, an insulating layer 140, a first common electrode 150 and a first alignment film layer 160.

The first substrate 110 may be, for example, a transparent glass substrate or a resin substrate, but the present disclosure is not limited thereto.

The black matrix 120 is arranged on the first substrate 110 and limits a plurality of pixel area PX. These pixel area PX are arranged in an array.

The plurality of colored light blocking blocks 130 are arranged on the first substrate 110, and one colored light blocking block 130 is located in the corresponding one pixel area PX.

In the present embodiment, the colored light blocking block 130 is a red light blocking block or a green light blocking block or a blue light blocking block, the present disclosure is not limited thereto, the colored light blocking block 130 may be a light blocking block of any suitable color, the plurality of colored light blocking blocks 130 include a red light blocking block, a green light blocking block, and a blue light blocking block. In the present embodiment, a red light blocking block, a green light blocking block, and a blue light blocking block are a light blocking block unit arranged in array.

The insulating layer 140 arranged on the black matrix 120 and the plurality of colored light blocking blocks 130. The insulating layer 160 may be formed of an inorganic insulating material or an organic insulating material.

The first common electrode 150 is arranged on the insulating layer 140. As an embodiment of the present disclosure, the first common electrode 150 may be formed of indium tin oxide (ITO), but the present disclosure is not limited thereto.

The first alignment film layer 160 is arranged on the first common electrode 150.

The array substrate 200 includes: a second substrate 210, a plurality of thin film transistors 220, a flat layer 230, a plurality of second common electrodes 240, a plurality of pixel electrodes 250, a plurality of insulators 260 and a second alignment film layer 270.

The second substrate 210 may be, for example, a transparent glass substrate or a resin substrate, but the present disclosure is not limited thereto.

The plurality of thin film transistors 220 are arrayed on the second substrate 210. One thin film transistor 220 corresponds to one pixel area PX.

As an embodiment of the present disclosure, the thin film transistor 220 includes: a gate electrode 221 arranged on the second substrate 210, a gate insulating layer 222 arranged on the gate electrode 221, an active layer 223 arranged on the gate insulating layer 222, a source electrode 224 and a drain electrode 225 arranged on the active layer 223. It should be noted that the structure of the thin film transistor 220 is not limited to those described herein and may be a thin film transistor of other suitable structures.

The flat layer 230 is arranged on the second substrate 210 and covering the plurality of thin film transistors 220.

The second common electrode 240 and the pixel electrode 250 are alternately disposed over the flat layer 230, and the second common electrode 240 and the pixel electrode 250 are electrically insulated from each other. In order to achieve this object, the present embodiment employs a plurality of insulators 260 arranged on the flat layer 230 at intervals, arranging each pixel electrode 250 on a corresponding insulator 260, arranging each of the second common electrodes 240 on the corresponding two adjacent insulators 260. It is to be noted that the present disclosure may employ any other suitable method in which the second common electrode 240 and the pixel electrode 250 are alternately disposed on the flat layer 230 and the second common electrode 240 and the pixel electrode 250 are electrically insulated from each other. As an embodiment of the present disclosure, the second common electrode 240 may be formed of, for example, indium tin oxide (ITO), but the present disclosure is not limited thereto. As one embodiment of the present disclosure, the pixel electrode 250 may be formed of indium tin oxide (ITO), for example, but the present disclosure is not limited thereto.

In the present embodiment, the second common electrode 240 and/or the pixel electrode 250 and/or the insulator 260 are in a stripe shape, but the present disclosure is not limited thereto. Here, it is to be noted that a plurality of pixel electrodes 250 corresponding to one pixel area PX are connected together, and a plurality of pixel electrodes 250 respectively corresponding to the two adjacent pixel areas PX are electrically insulated from each other. In addition, a plurality of second common electrodes 240 of the array substrate 200 are connected together.

Further, the pixel electrode 250 above each thin film transistor 220 penetrates the corresponding insulator 260 and the flat layer 230 to contact the drain electrode 225.

Further, the spacers 300 are arranged opposite the black matrix 120 and the thin film transistor 220 in order to prevent the spacer 300 from blocking the light to pass through the colored light blocking block 130.

In the present embodiment, the first alignment film layer and the second alignment film layer are subjected to UV exposure using UV light with a wavelength of 200 nm to 500 nm, respectively, so that the liquid crystal molecules are pre-deflected at a predetermined angle (i.e. molecule has a tilt angle of a predetermined angle). Further, the pre-deflection direction of the liquid crystal molecules near the first alignment film layer 160 of the liquid crystal layer 400 antiparallel to the pre-deflection direction of the liquid crystal molecules near the second alignment film layer 270 of the liquid crystal layer 400. The liquid crystal molecules in the liquid crystal layer 400 are nearly perpendicular to the first substrate 110 and the second substrate 210 when voltage is not applied to the color film substrate 100 and the array substrate 200, and when voltage is applied to the color film substrate 100 and the array substrate 200, the liquid crystal molecules in the liquid crystal layer 400 are tilted so as to be horizontal with the first substrate 110 and the second substrate 210.

In summary, the liquid crystal panel of the present embodiment has a high contrast ratio and a high transmittance, and has characteristics of fast response and wide viewing angle, in combination with the characteristics of the VA display mode and the IPS display mode.

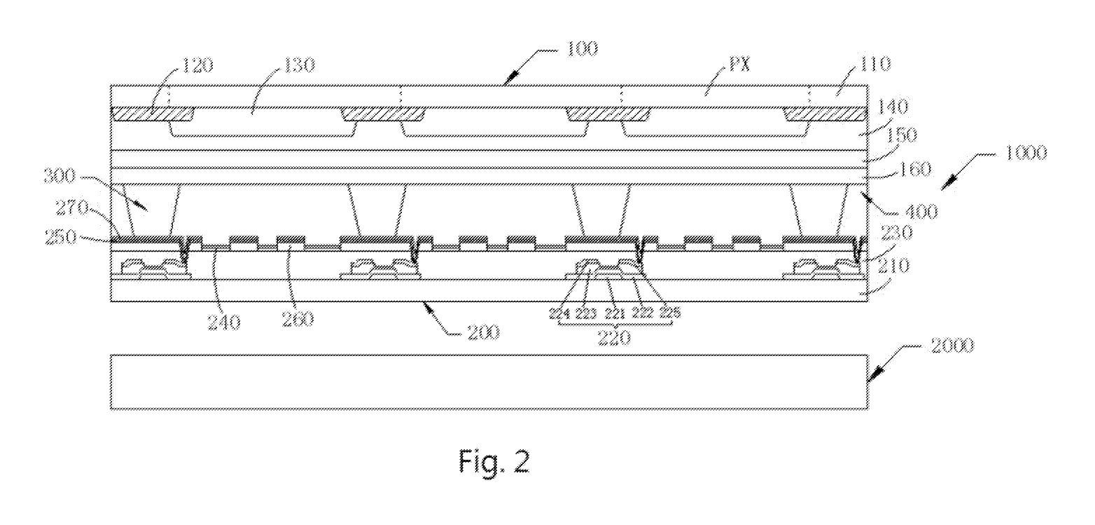

FIG. 2 is a schematic structural view of the liquid crystal display of the embodiment of the present disclosure.

Refer to FIG. 2, the liquid crystal display according to the embodiment of the present disclosure includes: the liquid crystal panel 1000 and the backlight module 2000 shown in FIG. 1. The backlight module 2000 is arranged on the side of the array substrate 200 of the liquid crystal panel 1000 facing away from the color film substrate 100, so that the light emitted from the backlight module 2000 passes through the array substrate 200 and the color film substrate 100 in order to display images.

Although reference to particular embodiments shown and described the present disclosure, those skilled in the art will understand: without departing from the spirit and scope of the appended claims and their equivalents of the present disclosure, a case, in this that various changes in form and details.

What is claimed is:

1. An array substrate for a liquid crystal panel, comprising:
a substrate;
a plurality of thin film transistors arrayed on the substrate;
a flat layer arranged on the substrate and covering the plurality of thin film transistors;
a plurality of first common electrodes and a plurality of pixel electrodes, the first common electrode and the pixel electrode being alternately arranged on the flat layer, the first common electrode and the pixel electrode being electrically insulated from each other;
and a first alignment film layer arranged on the first common electrode and the pixel electrode, and the first alignment film layer is an alignment film layer capable of realizing vertical photo alignment.

2. The array substrate according to claim 1, wherein, the array substrate further comprises: a plurality of insulators each disposed between its corresponding pixel electrode and the flat layer, each first common electrode is located between its corresponding two adjacent insulators.

3. The array substrate according to claim 2, wherein, the insulator and/or the first common electrode and/or the pixel electrode are in a stripe shape.

4. The array substrate according to claim 2, wherein, the thin film transistor comprises: a gate electrode arranged on the substrate, a gate insulating layer arranged on the gate electrode, an active layer arranged on the gate insulating layer and a source electrode and a drain electrode arranged on the active layer; wherein a pixel electrode arranged on each thin film transistor penetrates its corresponding insulator and the flat layer to contact the drain electrode.

5. A color film substrate for a liquid crystal panel, comprising:
a substrate;
a black matrix arranged on the substrate and limiting a plurality of pixel areas;
a plurality of colored light blocking blocks arranged on the substrate, each colored light blocking block being located in its corresponding pixel area;
a insulating layer arranged on the black matrix and the plurality of colored light blocking blocks;
a second common electrode arranged on the insulating layer;
and a second alignment film layer arranged on the second common electrode, and the second alignment film layer is an alignment film layer capable of realizing a vertical photo alignment.

6. The color film substrate according to claim 5, wherein, the colored light blocking block is a red light blocking block or a green light blocking block or a blue light blocking block, and the plurality of colored light blocking blocks comprise a red light blocking block, a green light blocking block and a blue light blocking block.

7. A liquid crystal panel, comprising:
the array substrate according to claim 1;
the color film substrate according to claim 5, wherein the color film substrate is arranged in a pair with the array substrate;
and a liquid crystal layer arranged between the array substrate and the color film substrate.

8. The liquid crystal panel according to claim 7, wherein, the liquid crystal molecules in the liquid crystal layer are aligned in the following manner: the first alignment film layer and the second alignment film layer are respectively subjected to UV exposure using ultraviolet light having a wavelength of 200 nm to 500 nm, and the liquid crystal molecules are caused to form a pre-deflection at a predetermined angle.

9. The liquid crystal panel according to claim 8, wherein, the pre-deflection direction of the liquid crystal molecules near the first alignment film layer of the liquid crystal layer antiparallel to the pre-deflection direction of the liquid crystal molecules near the second alignment film layer of the liquid crystal layer.

10. The liquid crystal panel according to claim 7, wherein, the liquid crystal panel further comprises: a spacer arranged between the color film substrate and the array substrate, and the spacers are used for maintaining a pitch between the color film substrate and the array substrate.

11. The liquid crystal panel according to claim 8, wherein, the liquid crystal panel further comprises: a spacer arranged between the color film substrate and the array substrate, and the spacers are used for maintaining a pitch between the color film substrate and the array substrate.

12. The liquid crystal panel according to claim 9, wherein, the liquid crystal panel further comprises: a spacer arranged between the color film substrate and the array substrate, and the spacers are used for maintaining a pitch between the color film substrate and the array substrate.
